(19) United States
(12) Patent Application Publication
(10) Pub. No.: US 2026/0147096 A1
(43) Pub. Date: May 28, 2026

(54) OPTICAL EDGE COUPLER FOR DESCAN MITIGATION IN LIDAR

(71) Applicant: AEVA, INC., Mountain View, CA (US)

(72) Inventors: Bing Shen, Sunnyvale, CA (US); Pradeep Srinivasan, Fremont, CA (US)

(21) Appl. No.: 18/958,962

(22) Filed: Nov. 25, 2024

(51) Int. Cl. G01S 7/481; G01S 17/42; G01S 17/58

(52) U.S. Cl. CPC G01S 7/4817; G01S 7/4818; G01S 17/42; G01S 17/58

(57) ABSTRACT

The system includes an optical element to receive, responsive to transmitting the optical beam, a first returned reflection having a first lag angle relative to the optical axis. The optical element is to steer, based on the first lag angle, the first returned reflection to generate a first steered beam that is separated from the optical axis by a first offset. The system includes a multi-tip coupler that includes multiple tips. The multi-tip coupler is to receive, from the optical element, a peak power of the first steered beam at an input of a first tip of the multi-tip coupler. The input of the first tip is separated from the optical axis by the first offset. The multi-tip coupler is to combine energy from the multiple tips of the multiple-tip coupler to generate a first single mode signal to be used for detecting a position of the first object.

### TECHNICAL FIELD

The present disclosure relates generally to optical detection, and more particularly to systems and methods of an optical edge coupler for descan mitigation in a light detection and ranging (LIDAR) system to enhance detection of distant objects.

### BACKGROUND

A LIDAR system includes an optical scanner to transmit a frequency-modulated continuous wave (FMCW) infrared (IR) optical beam and to receive a return signal from reflections of the optical beam; an optical processing system coupled with the optical scanner to generate a baseband signal in the time domain from the return signal, where the baseband signal includes frequencies corresponding to LIDAR target ranges; and a signal processing system coupled with the optical processing system to measure energy of the baseband signal in the frequency domain, to compare the energy to an estimate of LIDAR system noise, and to determine a likelihood that a signal peak in the frequency domain indicates a detected target.

### SUMMARY

One aspect disclosed herein is directed to a method including transmitting, by an optical scanner, an optical beam towards a first object based on a transmit optical beam that propagates along an optical axis. The method includes receiving, by an optical element responsive to transmitting the optical beam, a first returned reflection having a first lag angle relative to the optical axis. The method includes steering, by the optical element based on the first lag angle, the first returned reflection to generate a first steered beam that is separated from the optical axis by a first offset. The method includes receiving, from the optical element, a peak power of the first steered beam at an input of a first tip of a multi-tip coupler, the input of the first tip is separated from the optical axis by the first offset. The method includes combining, by the multi-tip coupler, energy from multiple tips of the multi-tip coupler to generate a first single mode signal to be used for detecting a position of the first object.

In another aspect, the present disclosure is directed to a system that includes an optical element to receive, responsive to transmitting the optical beam, a first returned reflection having a first lag angle relative to the optical axis. The optical element is to steer, based on the first lag angle, the first returned reflection to generate a first steered beam that is separated from the optical axis by a first offset. The system includes a multi-tip coupler that includes multiple tips. The multi-tip coupler is to receive, from the optical element, a peak power of the first steered beam at an input of a first tip of the multi-tip coupler. The input of the first tip is separated from the optical axis by the first offset. The multi-tip coupler is to combine energy from the multiple tips of the multiple-tip coupler to generate a first single mode signal to be used for detecting a position of the first object.

In another aspect, the present disclosure is directed to a system including a first optical element to receive a plurality of returned reflections that are respectively associated with a plurality of lag angles relative to an optical axis. The system includes a multi-tip coupler including multiple tips. The multi-tip coupler is to receive, for each returned reflection of the plurality of returned reflections, different amounts of power of the returned reflection at different tips of the multiple tips. The multi-tip coupler generates a plurality of single mode signals based on the different amounts of power. The system includes a processing device coupled to the multi-tip coupler. The processing device is to detect a plurality of object positions based on the plurality of single mode signals.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable unless the context of the disclosure clearly dictates otherwise.

It will therefore be appreciated that this summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects, and advantages will become apparent from the following detailed description taken in conjunction with the accompanying figures which illustrate, by way of example, the principles of some described example implementations.

### BRIEF DESCRIPTION OF THE FIGURE(S)

Embodiments and implementations of the present disclosure will be understood more fully from the detailed description given below and from the accompanying drawings of various aspects and implementations of the disclosure, which, however, should not be taken to limit the disclosure to the specific embodiments or implementations, but are for explanation and understanding only.

FIG. 1 is a block diagram illustrating an example of a LIDAR system, according to some embodiments;

FIG. 2 is a time-frequency diagram illustrating an example of an FMCW scanning signal that can be used by a LIDAR system to scan a target environment, according to some embodiments;

FIG. 3 is a block diagram illustrating an example environment for using an optical scanner to transmit optical beams towards distant objects and receive returned optical beams having different lag angles, according to some embodiments;

FIG. 4 is a block diagram illustrating an example environment for using a fork edge-coupler based light-chip coupling method for descan mitigation in the LIDAR system in FIG. 1 to enhance detection of distant objects, according to some embodiments;

FIG. 5 is a block diagram illustrating the features of an example fork-edge coupler, according to some embodiments; and

FIG. 6 is a flow diagram illustrating an example method of using a fork edge-coupler for descan mitigation in an FMCW LIDAR system to enhance detection of distant objects, according to some embodiments.

### DETAILED DESCRIPTION

According to some embodiments, the described LIDAR system using programmable beam steering compensation may be implemented in a variety of sensing and detection applications, such as, but not limited to, automotive, communications, consumer electronics, and healthcare markets. According to some embodiments, the described LIDAR system using programmable beam steering compensation may be implemented as part of a front-end of frequency modulated continuous-wave (FMCW) device that assists with spatial awareness for automated driver assist systems, or self-driving vehicles. According to some embodiments, the disclosed configuration may be agnostic to specific optical scanning architecture and can be tailored to enhance scanning LIDAR performance for a desired target range and/or to increase frame rate for a given range on the fly.

In a coherent LIDAR system, a frequency-modulated continuous wave (FMCW) transmitted light source (Tx) is used to determine the distance and velocity of objects in the scene by mixing a copy of the Tx source, known as the local oscillator (LO), with the received light (Rx) from the scene. The LO and Rx paths are combined on a fast photodiode (e.g., a photodetector), producing beat frequencies, proportional to object distance, which are processed electronically to reveal distance and velocity information of objects in the scene. To generate a point-cloud image, scanning optics are commonly used to deflect the Tx beam (e.g., signal) through the system field of view (FOV), including azimuth and zenith angles. In many applications, it is desirable to simultaneously achieve the highest possible scan rate and a large signal-to-noise ratio (SNR), as these two parameters directly affect the frame-rate of the LIDAR system, its maximum range (e.g., distance), range and velocity resolution, and the lateral spatial resolution.

However, increasing the scan rate produces a larger lag angle between the Rx light from a given object and the corresponding local oscillator (LO) that the LIDAR system uses to process the Rx light. This lag angle effect creates a “beam walk-off” or “beam offset” problem, where the Tx light returned from distant objects are offset from the LO, which limits the achievable scan/frame rate and maximum range of the LIDAR system. Furthermore, the detection of objects at a large range also produces large beat frequencies. Therefore, detecting distant objects with high fidelity requires the use of analog-to-digital convertors (ADCs) with very large sampling rates, approaching Giga-samples per second (Gsps), which consume a large amount of power.

Accordingly, the present disclosure addresses the above-noted and other deficiencies by disclosing systems and methods for using a fork edge-coupler (FC) based light-chip coupling method for descan mitigation in LIDAR. The FC (sometimes referred to as a fork coupler) is composed of multiple coupled tips that are configured to send and collect (e.g., receive) light. The FC can have a mode with Mode Field Diameter (MFD) that is tens of microns wide in the lateral direction, while keeping the MFD in the vertical direction a few microns. Since the impact of descan on chip-light coupling efficiency is inversely proportional to the mode size, the FC with a larger MFD would actually exhibit much less loss penalty from descan. Furthermore, by tuning the tip width and gap between tips, the eigen mode of the can be decreased and increased along the direction that is parallel to the chip surface. With a reasonably large mode of FC in lateral direction, the fork edge-coupler can achieve significant improved light-chip coupling efficiency with considerable descan.

In an illustrative embodiment, an FMCW LIDAR system includes an optical scanner to transmit an optical beam towards a first object based on a transmit optical beam that propagates along an optical axis. The FMCW LIDAR system includes an optical element that receives, responsive to transmitting the optical beam, a first returned reflection that has a first lag angle relative to the optical axis. The optical element steers, based on the first lag angle, the first returned reflection to generate a first steered beam that is separated from the optical axis by a first offset. The FMCW LIDAR system includes a multi-tip coupler that includes multiple tips. The multi-tip coupler receives, from the optical element, a peak power of the first steered beam at an input of a first tip of the multi-tip coupler, where the input of the first tip is separated from the optical axis by the first offset. The multi-tip coupler combines energy from the multiple tips of the multiple-tip coupler to generate a first single mode signal to be used for detecting a position of the first object.

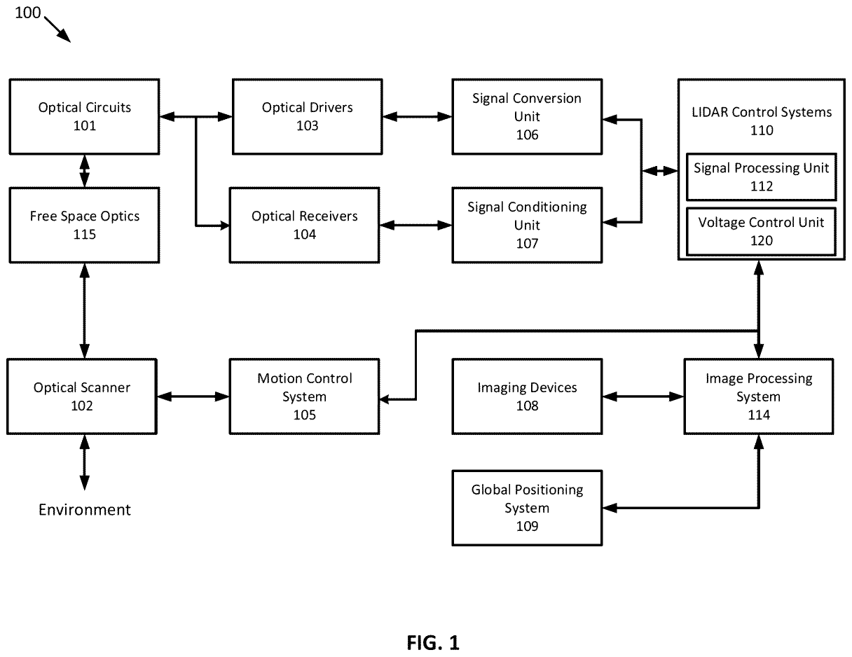

FIG. 1 is a block diagram illustrating an example of a LIDAR system, according to some embodiments. The LIDAR system 100 includes one or more of each of a number of components, but may include fewer or additional components than shown in FIG. 1. One or more of the components depicted in FIG. 1 can be implemented on a photonics chip, according to some embodiments. The optical circuits 101 may include a combination of active optical components and passive optical components. Active optical components may generate, amplify, and/or detect optical signals and the like. In some examples, the active optical component includes optical beams at different wavelengths, and includes one or more optical amplifiers, one or more optical detectors, or the like. In some embodiments, one or more LIDAR systems 100 may be mounted onto any area (e.g., front, back, side, top, bottom, and/or underneath) of a vehicle to facilitate the detection of an object in any free space relative to the vehicle. In some embodiments, the vehicle may include a steering system and a braking system, each of which may work in combination with one or more LIDAR systems 100 according to any information (e.g., distance/ranging information, Doppler information, etc.) acquired and/or available to the LIDAR system 100. In some embodiments, the vehicle may include a vehicle controller that includes the one or more components and/or processors of the LIDAR system 100.

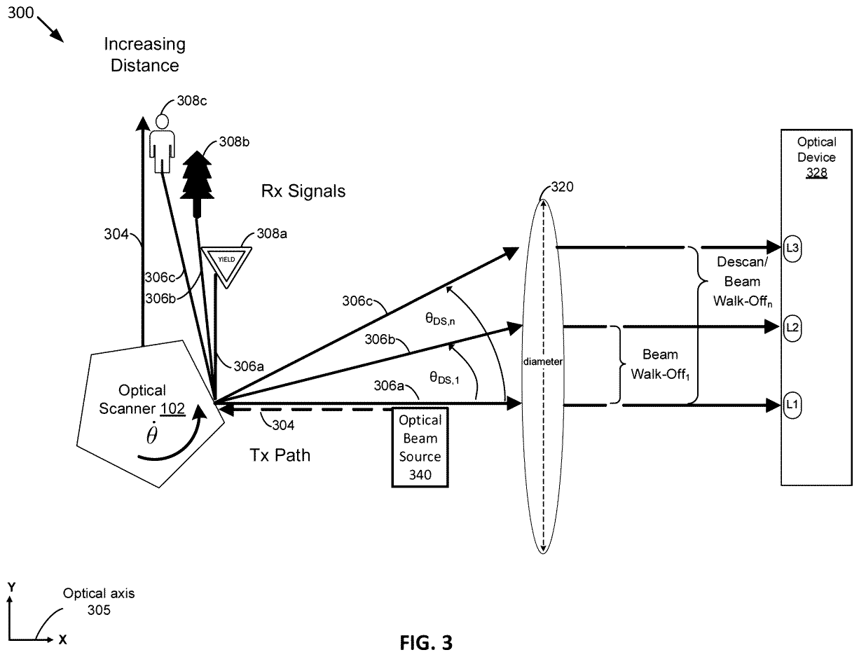

Free space optics 115 may include one or more optical waveguides to carry optical signals, and route and manipulate optical signals to appropriate input/output ports of the active optical circuit. In embodiments, the one or more optical waveguides may include one or more graded index waveguides, as will be described in additional detail below at FIGS. 3-6. The free space optics 115 may also include one or more optical components such as taps, wavelength division multiplexers (WDM), splitters/combiners, polarization beam splitters (PBS), collimators, couplers or the like. In some examples, the free space optics 115 may include components to transform the polarization state and direct received polarized light to optical detectors using a PBS, for example. The free space optics 115 may further include a diffractive element to deflect optical beams having different frequencies at different angles along an axis (e.g., a fast-axis).

In some examples, the LIDAR system 100 includes an optical scanner 102 that includes one or more scanning mirrors that are rotatable along an axis (e.g., a slow-axis) that is orthogonal or substantially orthogonal to the fast-axis of the diffractive element to steer optical signals to scan an environment according to a scanning pattern. For instance, the scanning mirrors may be rotatable by one or more galvanometers. Objects in the target environment may scatter an incident light into a return optical beam or a target return signal. The optical scanner 102 also collects the return optical beam or the target return signal, which may be returned to the passive optical circuit component of the optical circuits 101. For example, the return optical beam may be directed to an optical detector by a polarization beam splitter. In addition to the mirrors and galvanometers, the optical scanner 102 may include components such as a quarter-wave plate, lens, anti-reflective coated window or the like.

To control and support the optical circuits 101 and optical scanner 102, the LIDAR system 100 includes LIDAR control systems 110. The LIDAR control systems 110 may include a processing device for the LIDAR system 100. In some examples, the processing device may be one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. The processing device may also be one or more special-purpose processing devices such as an application specific integrated circuit (ASIC), a field programmable gate array (FPGA), a digital signal processor (DSP), network processor, or the like.

In some examples, the LIDAR control system 110 may include a processing device that may be implemented with a DSP, such as signal processing unit 112. The LIDAR control systems 110 are configured to output digital control signals to control optical drivers 103. In some examples, the digital control signals may be converted to analog signals through signal conversion unit 106. For example, the signal conversion unit 106 may include a digital-to-analog converter. The optical drivers 103 may then provide drive signals to active optical components of optical circuits 101 to drive optical sources such as lasers and amplifiers. In some examples, several optical drivers 103 and signal conversion units 106 may be provided to drive multiple optical sources.

The LIDAR control systems 110 are also configured to output digital control signals for the optical scanner 102. A motion control system 105 may control the galvanometers of the optical scanner 102 based on control signals received from the LIDAR control systems 110. For example, a digital-to-analog converter may convert coordinate routing information from the LIDAR control systems 110 to signals interpretable by the galvanometers in the optical scanner 102. In some examples, a motion control system 105 may also return information to the LIDAR control systems 110 about the position or operation of components of the optical scanner 102. For example, an analog-to-digital converter may in turn convert information about the galvanometers'position to a signal interpretable by the LIDAR control systems 110.

The LIDAR control systems 110 are further configured to analyze incoming digital signals. In this regard, the LIDAR system 100 includes optical receivers 104 to measure one or more beams received by optical circuits 101. For example, a reference beam receiver may measure the amplitude of a reference beam from the active optical component, and an analog-to-digital converter converts signals from the reference receiver to signals interpretable by the LIDAR control systems 110. Target receivers measure the optical signal that carries information about the range and velocity of a target in the form of a beat frequency, modulated optical signal. The reflected beam may be mixed with a second signal from a local oscillator. The optical receivers 104 may include a high-speed analog-to-digital converter to convert signals from the target receiver to signals interpretable by the LIDAR control systems 110. In some examples, the signals from the optical receivers 104 may be subject to signal conditioning by signal conditioning unit 107 prior to receipt by the LIDAR control systems 110. For example, the signals from the optical receivers 104 may be provided to an operational amplifier for amplification of the received signals and the amplified signals may be provided to the LIDAR control systems 110.

In some applications, the LIDAR system 100 may additionally include one or more imaging devices 108 configured to capture images of the environment, a global positioning system 109 configured to provide a geographic location of the system, or other sensor inputs. The LIDAR system 100 may also include an image processing system 114. The image processing system 114 can be configured to receive the images and geographic location, and send the images and location or information related thereto to the LIDAR control systems 110 or other systems connected to the LIDAR system 100.

In operation according to some examples, the LIDAR system 100 is configured to use nondegenerate optical sources to simultaneously measure range and velocity across two dimensions. This capability allows for real-time, long range measurements of range, velocity, azimuth, and elevation of the surrounding environment.

In some examples, the scanning process begins with the optical drivers 103 and LIDAR control systems 110. The LIDAR control systems 110 instruct, e.g., via signal processing unit 112, the optical drivers 103 to independently modulate one or more optical beams, and these modulated signals propagate through the optical circuits 101 to the free space optics 115. The free space optics 115 directs the light at the optical scanner 102 that scans a target environment over a preprogrammed pattern defined by the motion control system 105. The optical circuits 101 may also include a polarization wave plate (PWP) to transform the polarization of the light as it leaves the optical circuits 101. In some examples, the polarization wave plate may be a quarter-wave plate or a half-wave plate. A portion of the polarized light may also be reflected back to the optical circuits 101. For example, lensing or collimating systems used in LIDAR system 100 may have natural reflective properties or a reflective coating to reflect a portion of the light back to the optical circuits 101.

Optical signals reflected back from an environment pass through the optical circuits 101 to the optical receivers 104. Because the polarization of the light has been transformed, it may be reflected by a polarization beam splitter along with the portion of polarized light that was reflected back to the optical circuits 101. In such scenarios, rather than returning to the same fiber or waveguide serving as an optical source, the reflected signals can be reflected to separate optical receivers 104. These signals interfere with one another and generate a combined signal. The combined signal can then be reflected to the optical receivers 104. Also, each beam signal that returns from the target environment may produce a time-shifted waveform. The temporal phase difference between the two waveforms generates a beat frequency measured on the optical receivers 104 (e.g., photodetectors).

The analog signals from the optical receivers 104 are converted to digital signals by the signal conditioning unit 107. These digital signals are then sent to the LIDAR control systems 110. A signal processing unit 112 may then receive the digital signals to further process and interpret them. In some embodiments, the signal processing unit 112 also receives position data from the motion control system 105 and galvanometers (not shown) as well as image data from the image processing system 114. The signal processing unit 112 can then generate 3D point cloud data (sometimes referred to as, “a LIDAR point cloud”) that includes information about range and/or velocity points in the target environment as the optical scanner 102 scans additional points. In some embodiments, a LIDAR point cloud may correspond to any other type of ranging sensor that is capable of Doppler measurements, such as Radio Detection and Ranging (RADAR). The signal processing unit 112 can also overlay 3D point cloud data with image data to determine velocity and/or distance of objects in the surrounding area. The signal processing unit 112 also processes the satellite-based navigation location data to provide data related to a specific global location.

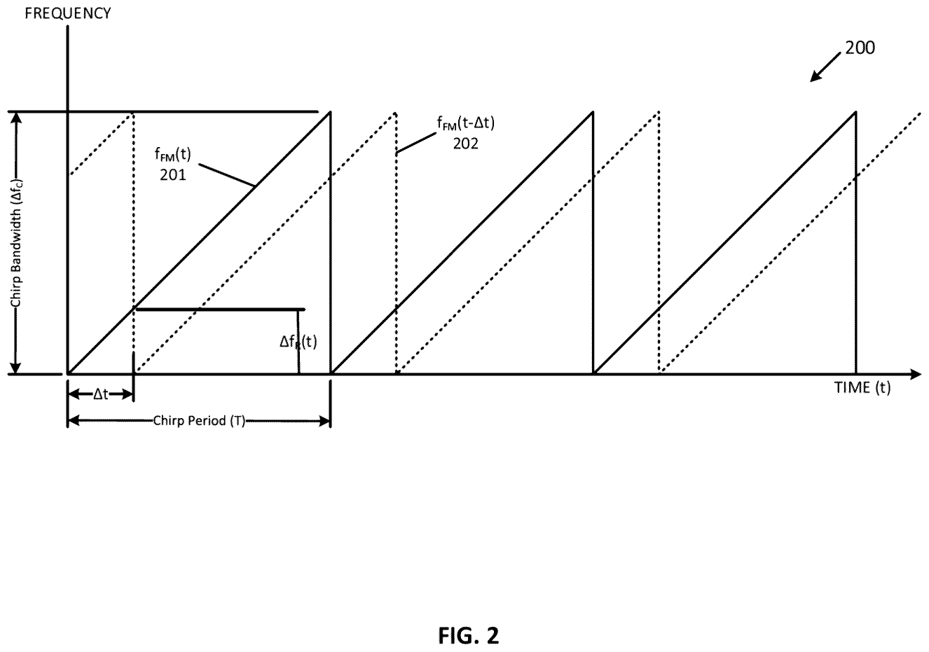

FIG. 2 is a time-frequency diagram illustrating an example of an FMCW scanning signal that can be used by a LIDAR system to scan a target environment, according to some embodiments. In one example, the scanning waveform 201, labeled as f_{FM}(t), is a sawtooth waveform (sawtooth “chirp”) with a chirp bandwidth Δf_{C} and a chirp period T_{C}. The slope of the sawtooth is given as k=(Δf_{C}/T_{C}). FIG. 2 also depicts target return signal 202 according to some embodiments. Target return signal 202, labeled as f_{FM}(t−Δt), is a time-delayed version of the scanning waveform 201, where Δt is the round trip time to and from a target illuminated by scanning waveform 201. The round trip time is given as Δt=2R/ν, where R is the target range and ν is the velocity of the optical beam, which is the speed of light c. The target range, R, can therefore be calculated as R=c(Δt/2). When the return signal 202 is optically mixed with the scanning signal, a range-dependent difference frequency (“beat frequency”) Δf_{R}(t) is generated. The beat frequency Δf_{R}(t) is linearly related to the time delay Δt by the slope of the sawtooth k. That is, Δf_{R}(t)=kΔt. Since the target range R is proportional to Δt, the target range R can be calculated as R=(c/2)(Δf_{R}(t)/k). That is, the range R is linearly related to the beat frequency Δf_{R}(t). The beat frequency Δf_{R}(t) can be generated, for example, as an analog signal in optical receivers 104 of system 100. The beat frequency can then be digitized by an analog-to-digital converter (ADC), for example, in a signal conditioning unit such as signal conditioning unit 107 in LIDAR system 100. The digitized beat frequency signal can then be digitally processed, for example, in a signal processing unit, such as signal processing unit 112 in system 100. It should be noted that the target return signal 202 will, in general, also includes a frequency offset (Doppler shift) if the target has a velocity relative to the LIDAR system 100. The Doppler shift can be determined separately, and used to correct (e.g., adjust, modify) the frequency of the return signal, so the Doppler shift is not shown in FIG. 2 for simplicity and ease of explanation. For example, LIDAR system 100 may correct the frequency of the return signal by removing (e.g., subtracting, filtering) the Doppler shift from the frequency of the returned signal to generate a corrected return signal. The LIDAR system 100 may then use the corrected return signal to calculate a distance and/or range between the LIDAR system 100 and the object. In some embodiments, the Doppler frequency shift of target return signal 202 that is associated with an object may be indicative of a velocity and/or movement direction of the object relative to the LIDAR system 100.

It should also be noted that the sampling frequency of the ADC will determine the highest beat frequency that can be processed by the system without aliasing. In general, the highest frequency that can be processed is one-half of the sampling frequency (i.e., the “Nyquist limit”). In one example, and without limitation, if the sampling frequency of the ADC is 1 gigahertz, then the highest beat frequency that can be processed without aliasing (Δf_{Rmax}) is 500 megahertz. This limit in turn determines the maximum range of the system as Rₘₐₓ=(c/2) (Δf_{Rmax}/k) which can be adjusted by changing the chirp slope k. In one example, while the data samples from the ADC may be continuous, the subsequent digital processing described below may be partitioned into “time segments” that can be associated with some periodicity in the LIDAR system 100. In one example, and without limitation, a time segment might correspond to a predetermined number of chirp periods T, or a number of full rotations in azimuth by the optical scanner.

FIG. 3 is a block diagram illustrating an example environment for using an optical scanner to transmit optical beams towards distant objects and receive returned optical beams corresponding to different lag angles and beam offsets, according to some embodiments. The environment 300 includes the optical scanner 102 (e.g., a prism, a mirror), an optical beam source 340, a collimation lens 320 (sometimes referred to as, “optical element”), and an optical device 328 (sometimes referred to as, “optical element”). In some embodiments, the optical device 328 may include or be one or more conventional waveguides. The optical device 328 may be a lens, a glass plate (sometimes referred to as, “local oscillator window”), or a beam steering unit. In some embodiments, the glass plate may be reflection coated glass plate or a partially reflective glass plate.

In some embodiments, any of the components (e.g., optical scanner 102, optical beam source 340, collimation lens 320, optical device 328, etc.) in the environment 300 may be added as a component of the LIDAR system 100 in FIG. 1, or be used to replace or modify any of the one or more components (e.g., free space optics 115, optical circuits, optical receivers 104, etc.) of the LIDAR system 100.

The environment 300 includes one or more objects, such as object 308a (e.g., a street sign), object 308b (e.g., a tree), and object 308c (e.g., a pedestrian); each collectively referred to as objects 308. Although FIG. 3 shows only a select number of objects 308, the environment 300 may include any number of objects 308 of any type (e.g., pedestrians, vehicles, street signs, raindrops, snow, street surface) that are within a short distance (e.g., 30 meters) or a long distance (e.g., 300 meters, 500 meters and beyond) from the optical scanner 102. In some embodiments, an object 308 may be stationary or moving with respect to the optical scanner 102.

In some embodiments, the optical scanner 102 is configured to receive one or more optical beams 304 (sometimes referred to as, “transmit optical beam”) transmitted from the optical beam source 340 along an optical axis 305 (shown in FIG. 3 as the X-axis). In some embodiments, the optical scanner 102 is configured to steer (e.g., redirect, transmit, scatter) the one or more optical beams 304 into free space toward the one or more objects 308, which causes the one or more optical beams to scatter into returned optical beams 306a, 306b, 306c (collectively referred to as, “returned optical beams 306”). For example, the one or more optical beams 304 scatter against the object 308a to create a returned optical beam 306a, which is returned to the LIDAR system 100. As another example, the one or more optical beams 304 scatter against the object 308b to create a returned optical beam 306b, which is returned to the LIDAR system 100. As another example, the one or more optical beams 304 scatter against the object 308c to create a returned optical beam 306c, which is returned to the LIDAR system 100.

The collimation lens 320 is configured (e.g., positioned, arranged) to collect (e.g., receive, acquire, aggregate) the returned optical beams 306 that scatter from the one or more objects 308 in response to the optical scanner 102 steering the one or more optical beams 304 into free space. In some embodiments, the collimation lens 320 may be a symmetric lens having a diameter. In some embodiments, the collimation lens 320 may be an asymmetric lens.

As shown in FIG. 3, the lag angle between a respective returned optical beam 306 and the collimation lens 320 is indicated by θ_{DS,n}, where n is an integer. For example, the lag angle between the returned optical beam 306a and the collimation lens 320 is indicated by θ_{DS,0} (not shown in FIG. 3), the lag angle between the returned optical beam 306b and the collimation lens 320 is indicated by θ_{DS,1}, and the lag angle between the returned optical beam 306c and the collimation lens 320 is indicated by θ_{DS,2} (shown in FIG. 3 as, θ_{DS,n}). In some embodiments, increasing the scan rate of the optical scanner 102 produces a larger lag angle between one or more of the returned optical beams 306.

As shown in FIG. 3, the optical device 328 receives the returned optical beam 306a at a location 1 (shown in FIG. 3 as, “L1”) on the optical device 328 from the collimation lens 320 as a result of the returned optical beam 306a having a lag angle of zero degrees with respect to the optical axis 305, and the collimation lens 320 generating a collimated beam from the returned optical beams 306. The optical device 328 also receives the returned optical beam 306b at a location 2 (shown in FIG. 3 as, “L2”) on the optical device 328 as a result of the returned optical beam 306b having a lag angle of θ_{DS,1} degrees with respect to the optical axis 305, and the collimation lens 320 generating a collimated beam from the returned optical beams 306. The optical device 328 also receives the returned optical beam 306c at a location 3 (shown in FIG. 3 as, “L3”) on the optical device 328 as a result of the returned optical beam 306c having a lag angle of θ_{DS,2} degrees with respect to the optical axis 305, and the collimation lens 320 generating a collimated beam from the returned optical beams 306.

In other words, the respectively increasing lag angles of the returned optical beams 306a, 306b, 306c from the distant objects cause the optical device 328 to receive the returned optical beams 306 at different locations on the optical device 328. The offset of a location on the optical device 328 with respect to the optical axis 305 is referred to as a beam walk-off (e.g., a distance). For example, the difference in distance between location 2, where the optical device 328 receives the returned optical beam 306b, and location 1, where the optical device 328 receives the returned optical beam 306a, is referred to as beam walk-off₁. The difference in distance between location 3, where the optical device 328 receives the returned optical beam 306c, and location 2, where the optical device 328 receives the returned optical beam 306b, is referred to as beam walk-off₂ (shown in FIG. 3 as, “beam walk-offₙ”).

Although not shown in FIG. 3, the optical device 328 couples to the LIDAR control system 110 in FIG. 1 such to be able to pass any of the returned optical beams that are received by the optical device 328 to the LIDAR control system 110 for processing by the signal processing unit 112.

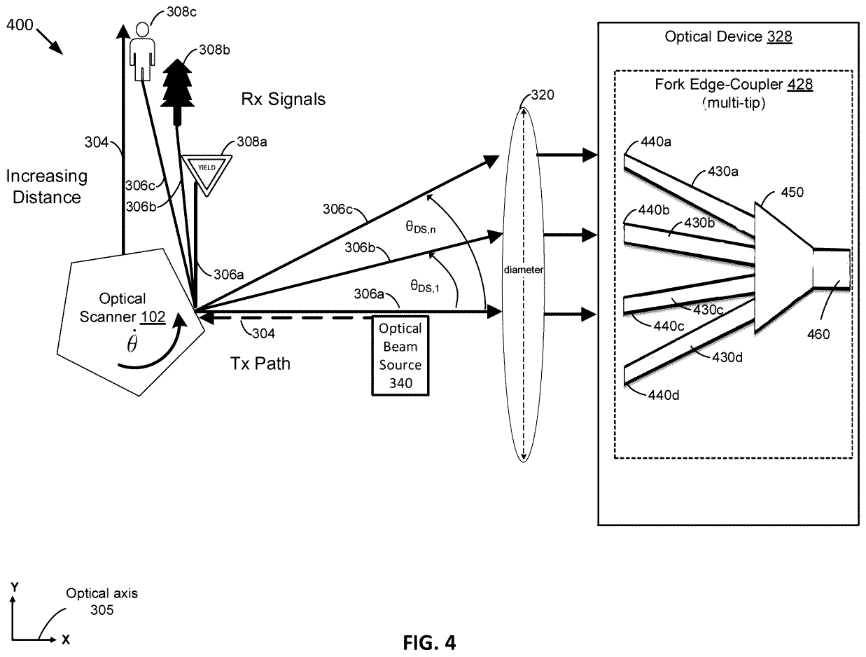

FIG. 4 is a block diagram illustrating an example environment for using a fork edge-coupler based light-chip coupling method for descan mitigation in the LIDAR system in FIG. 1 to enhance detection of distant objects, according to some embodiments. The environment 400 includes the optical scanner 102, the collimation lens 320 (sometimes referred to as, “lens 3”), and the optical beam source 340. The environment 400 includes the optical device 328 from FIG. 3, but where the optical device 328 includes a fork edge-coupler (FC) 428.

The FC 428 includes multiple tapers 430 (e.g., 430a, 430b, 430c, 430d) that respectively include multiple tips 440 (e.g., 440a, 440b, 440c, and 440d). The FC 428 also includes a combiner 450 and a single mode waveguide 460. In some embodiments, the FC 428 can include any number of tapers 430, such as 2 tapers, 3 tapers, 4 tapers, 5 tapers, etc.

In some embodiments, any of the components (e.g., optical scanner 102, optical beam source 340, collimation lens 320, optical device 328 with the FC 428, etc.) in the environment 400 may be added as a component of the LIDAR system 100 in FIG. 1, or be used to replace or modify any of the one or more components (e.g., free space optics 115, optical circuits, optical receivers 104, etc.) of the LIDAR system 100.

The environment 400 also includes object 308a (e.g., a street sign), object 308b (e.g., a tree), and object 308c (e.g., a pedestrian); each collectively referred to as objects 308. As was discussed with respect to FIG. 3, each of the objects 308 may be of any type and within a short distance (e.g., 30 meters) or a long distance (e.g., 300 meters, 500 meters and beyond) from the optical scanner 102. In some embodiments, an object 308 may be stationary or moving with respect to the optical scanner 102.

The optical scanner 102 is configured to receive an optical beam 304 transmitted from the optical beam source 340 along an optical axis 305 (shown in FIG. 4 as the X-axis). In some embodiments, the optical beam is an FMCW optical beam.

The optical scanner 102 is configured to receive, responsive to transmitting the optical beam, a first returned reflection having a first lag angle relative to the optical axis. The optical scanner 102 is configured to provide the first returned reflection to the collimation lens 320.

The collimation lens 320 is configured to steer, based on the first lag angle, the first returned reflection to generate a first steered beam that is separated from the optical axis by a first offset. The collimation lens 320 is configured to provide the first steered beam to the FC 428, where the first steered beam propagates parallel or substantially parallel to the optical axis.

The FC 428 is configured to receive, from the collimation lens 320, a peak power of the first steered beam at an input of a first tip (e.g., 440a) of the FC 428. As shown in FIG. 4, the input of the first tip is separated from the optical axis by the first offset. The combiner 450 of the FC 428 is configured to combine energy from the multiple tips (e.g., 440a-440d) of the FC 428 to generate a first single mode signal to be used for detecting a position of a first object (e.g., 308a).

The FC 428 is configured to receive, by a first tip (e.g., 440a), the peak power of the first steered beam. The FC 428 is configured to steer, using the first tip, the peak power of the first steered beam to propagate at a first beam angle and towards the optical axis. The FC 428 is configured to receive, by a second tip (e.g., 440b) of the FC 428 and from the collimation lens 320, a non-peak power of the first steered beam. The FC 428 is configured to steer, by the second tip of the FC 428, the non-peak power of the first steered beam to propagate at a second beam angle and towards the optical axis. As shown in FIG. 4, the first beam angle and the second beam angle are different.

Furthermore, in some embodiments, the remaining tips (e.g., 440b-440d) of the FC 428 do not receive the peak power of the first steered beam when the first tip (e.g., 440a) receives the peak power of the first steered beam. For example, the FC 428 is configured to receive a non-peak power of the first steered beam at an input of a second tip of the multi-tip coupler while the input of the first tip receives the peak power of the first steered beam.

The FC 428 may be a multi-channel, multi-tip coupler. In this embodiments, the FC 428 includes a first group of tips dedicated to a first channel and a second group of tips dedicated to a second channel.

The collimation lens 320 is configured to receive, responsive to transmitting the optical beam, a second returned reflection having a second lag angle relative to the optical axis. The is collimation lens 320 is configured to steer, based on the second lag angle, the second returned reflection to generate a second steered beam that is separated from the optical axis by a second offset. The collimation lens 320 is configured to provide the second returned reflection to the FC 428.

The FC 428 is configured to receive a peak power of the second steered beam at an input of a second tip (e.g., 440b) of the FC 428. As shown in FIG. 4, the input of the second tip is separated from the optical axis by the second offset. The FC 428 is configured to combine energy from its multiple tips to generate a second single mode signal to be used for detecting a position of a second object.

The FC 428 is configured to provide the first single mode signal to a processing device (e.g., LIDAR control system 110 in FIG. 1) via the single mode waveguide 460 of the FC 428.

In some embodiments, a designer may increase a maximum offset with respect to the optical axis that is supported by the FC 428 by adjusting at least one of a width of the input of the first tip or a gap between the input of the first tip and an input of a second tip of the FC 428. In some embodiments, a designer may minimize (e.g., reduce) an insertion loss of the combiner 450 of the FC 428 by adjusting at least one of a width of the first tip or a gap between the first tip and the second tip.

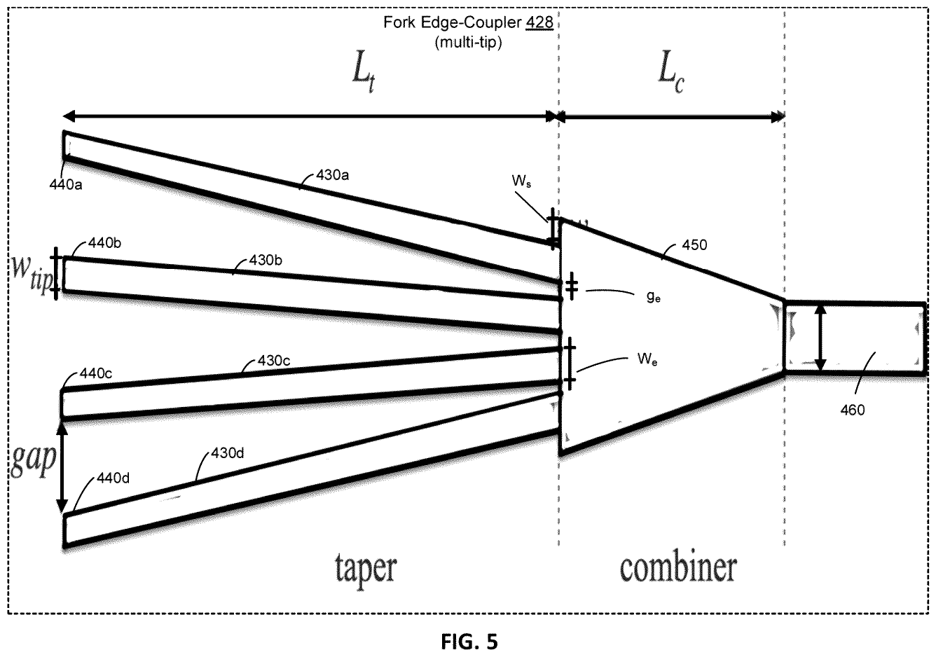

FIG. 5 is a block diagram illustrating a top view an example fork-edge coupler, according to some embodiments. The FC 428 includes multiple tapers 430 (e.g., 430a, 430b, 430c, 430d) that respectively include multiple tips 440 (e.g., 440a, 440b, 440c, and 440d). The FC 428 also includes a combiner 450 and a single mode waveguide 460. In some embodiments, the FC 428 can include any number of tapers 430, such as 2 tapers, 3 tapers, 4 tapers, 5 tapers, etc. Each teeth (e.g., a taper) can be considered as a coupler, and the whole structure is a composed of a couple of coupled light coupler. A design can adjust any or all of the components of the FC 428 to achieve a mode that is tens of times larger than one individual coupler. For example, a designer may increase a maximum offset with respect to the optical axis that is supported by the FC 428 by adjusting at least one of a width of the input of the first tip (e.g., 440a) or a gap between the input of the first tip and an input of a second tip (e.g., 440b) of the FC 428. As another example, a designer may minimize an insertion loss of the combiner 450 of the FC 428 by adjusting at least one of a width of the first tip (e.g., 440a) or a gap between the first tip (e.g., 440a) and the second tip (e.g., 440b).

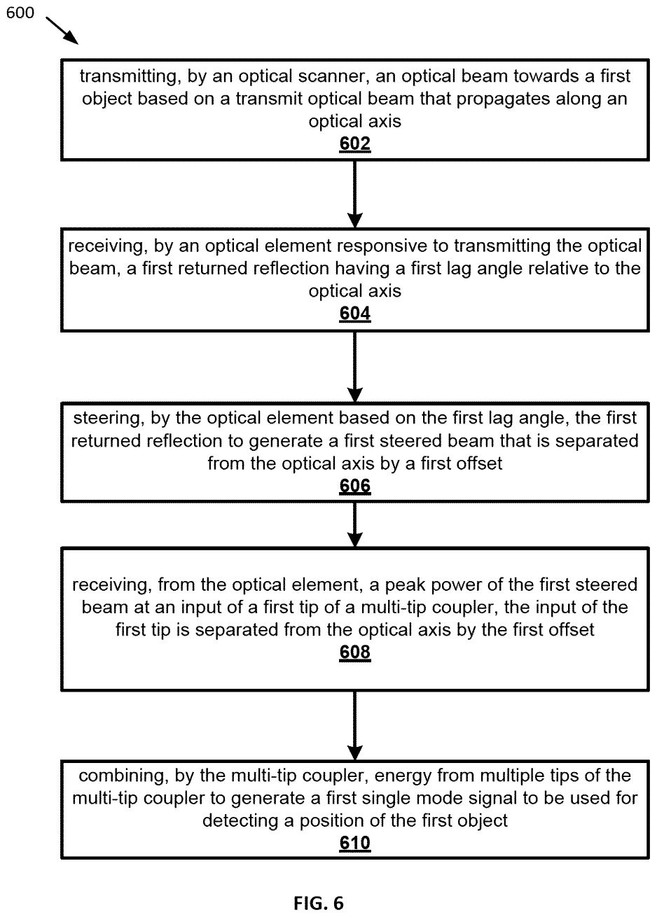

FIG. 6 is a flow diagram illustrating an example method of using a fork edge-coupler for descan mitigation in an FMCW LIDAR system to enhance detection of distant objects, according to some embodiments. Additional, fewer, or different operations may be performed in the method depending on the particular arrangement. In some embodiments, some or all operations of method 600 may be performed by one or more processors executing on one or more computing devices, systems, or servers (e.g., remote/networked servers or local servers). In some embodiments, method 600 may be performed by a signal processing unit, such as signal processing unit 112 in FIG. 1. In some embodiments, method 600 may be performed by any of the components (e.g., scanner 102, collimation lens 320, optical device 328 that includes FC 428, etc.) in environment 400 in FIG. 4. Each operation may be re-ordered, added, removed, or repeated.

In some embodiments, the method 600 may include the operation 602 of transmitting, by an optical scanner, an optical beam towards a first object based on a transmit optical beam that propagates along an optical axis. In some embodiments, the method 600 may include the operation 604 of receiving, by an optical element responsive to transmitting the optical beam, a first returned reflection having a first lag angle relative to the optical axis. In some embodiments, the method 600 may include the operation 606 of steering, by the optical element based on the first lag angle, the first returned reflection to generate a first steered beam that is separated from the optical axis by a first offset.

In some embodiments, the method 600 may include the operation 608 of receiving, from the optical element, a peak power of the first steered beam at an input of a first tip of a multi-tip coupler, the input of the first tip is separated from the optical axis by the first offset. In some embodiments, the method 600 may include the operation 610 of combining, by the multi-tip coupler, energy from multiple tips of the multi-tip coupler to generate a first single mode signal to be used for detecting a position of the first object.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. While this specification contains many specific implementation details, these should not be construed as limitations on the scope of any of the present embodiments or of what may be claimed, but rather as descriptions of features specific to particular embodiments of particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination. Moreover, the separation of various system components in the embodiments described above should not be understood as requiring such separation in all embodiments, and it should be understood that the described program components and systems can generally be integrated together in a single software product or packaged into multiple software products. Particular embodiments may vary from these exemplary details and still be contemplated to be within the scope of the present disclosure.

Reference throughout this specification to “one embodiment” or “an embodiment” means that a particular feature, structure, or characteristic described in connection with the embodiments included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

Although the operations of the methods herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be in an intermittent or alternating manner.

The above description of illustrated implementations of the present embodiments, including what is described in the Abstract, is not intended to be exhaustive or to limit the present embodiments to the precise forms disclosed. While specific implementations of, and examples for, the present embodiments are described herein for illustrative purposes, various equivalent modifications are possible within the scope of the present embodiments, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

What is claimed is:

1. A method comprising:
transmitting, by an optical scanner, an optical beam towards a first object based on a transmit optical beam that propagates along an optical axis;
receiving, by an optical element responsive to transmitting the optical beam, a first returned reflection having a first lag angle relative to the optical axis;
steering, by the optical element based on the first lag angle, the first returned reflection to generate a first steered beam that is separated from the optical axis by a first offset;
receiving, from the optical element, a peak power of the first steered beam at an input of a first tip of a multi-tip coupler, the input of the first tip is separated from the optical axis by the first offset; and
combining, by the multi-tip coupler, energy from multiple tips of the multi-tip coupler to generate a first single mode signal to be used for detecting a position of the first object.

2. The method of claim 1, wherein the first steered beam propagates parallel or substantially parallel to the optical axis, and further comprising:
receiving, by the first tip of the multi-tip coupler, the peak power of the first steered beam;
steering, by the first tip of the multi-tip coupler, the peak power of the first steered beam to propagate at a first beam angle and towards the optical axis;
receiving, by a second tip of the multi-tip coupler, a non-peak power of the first steered beam;
steering, by the second tip of the multi-tip coupler, the non-peak power of the first steered beam to propagate at a second beam angle and towards the optical axis, wherein the first beam angle and the second beam angle are different.

3. The method of claim 1, wherein remaining tips of the multi-tip coupler do not receive the peak power of the first steered beam.

4. The method of claim 1, further comprising:
receiving, from the optical element, a non-peak power of the first steered beam at an input of a second tip of the multi-tip coupler while the input of the first tip receives the peak power of the first steered beam.

5. The method of claim 4, wherein the multi-tip coupler comprises a first group of tips dedicated to a first channel and a second group of tips dedicated to a second channel.

6. The method of claim 1, further comprising:
receiving, by the optical element responsive to transmitting the optical beam, a second returned reflection having a second lag angle relative to the optical axis;
steering, by the optical element based on the second lag angle, the second returned reflection to generate a second steered beam that is separated from the optical axis by a second offset;
receiving, from the optical element, a peak power of the second steered beam at an input of a second tip of the multi-tip coupler, the input of the second tip is separated from the optical axis by the second offset; and
combining, by the multi-tip coupler, energy from the multiple tips of the multi-tip coupler to generate a second single mode signal to be used for detecting a position of a second object.

7. The method of claim 1, further comprising:
providing the first single mode signal to a processing device via a single mode waveguide of the multi-tip coupler.

8. The method of claim 1, further comprising:
increasing a maximum offset with respect to the optical axis that is supported by the multi-tip coupler by adjusting at least one of a width of the input of the first tip or a gap between the input of the first tip and an input of a second tip of the multi-tip coupler.

9. The method of claim 1, further comprising:
minimizing an insertion loss of a combiner of the multi-tip coupler by adjusting at least one of a width of the first tip or a gap between the first tip and the second tip.

10. The method of claim 1, wherein optical beam is a frequency-modulated continuous wave (FMCW) optical beam.

11. A frequency modulated continuous wave (FMCW) light detection and ranging (LIDAR) system comprising:
an optical scanner to:
transmit an optical beam towards a first object based on a transmit optical beam that propagates along an optical axis;
an optical element to:
receive, by an optical element responsive to transmitting the optical beam, a first returned reflection having a first lag angle relative to the optical axis;
steer, based on the first lag angle, the first returned reflection to generate a first steered beam that is separated from the optical axis by a first offset;
a multi-tip coupler comprising multiple tips, the multi-tip coupler to:
receive, from the optical element, a peak power of the first steered beam at an input of a first tip of the multi-tip coupler, the input of the first tip is separated from the optical axis by the first offset; and
combine energy from the multiple tips of the multiple-tip coupler to generate a first single mode signal to be used for detecting a position of the first object.

12. The FMCW LIDAR system of claim 11, wherein the first steered beam propagates parallel or substantially parallel to the optical axis, and wherein the multi-tip coupler is further to:
receive, by the first tip of the multi-tip coupler, the peak power of the first steered beam;
steer, by the first tip of the multi-tip coupler, the peak power of the first steered beam to propagate at a first beam angle and towards the optical axis;
receive, by a second tip of the multi-tip coupler, a non-peak power of the first steered beam;
steer, by the second tip of the multi-tip coupler, the non-peak power of the first steered beam to propagate at a second beam angle and towards the optical axis, wherein the first beam angle and the second beam angle are different.

13. The FMCW LIDAR system of claim 11, wherein remaining tips of the multi-tip coupler do not receive the peak power of the first steered beam.

14. The FMCW LIDAR system of claim 11, wherein the multi-tip coupler is further to:
receive, from the optical element, a non-peak power of the first steered beam at an input of a second tip of the multi-tip coupler while the input of the first tip receives the peak power of the first steered beam.

15. The FMCW LIDAR system of claim 14, wherein the multi-tip coupler further comprises a first group of tips dedicated to a first channel and a second group of tips dedicated to a second channel.

16. The FMCW LIDAR system of claim 11, wherein:
the optical element is further to:
receive, responsive to transmitting the optical beam, a second returned reflection having a second lag angle relative to the optical axis;
steer, based on the second lag angle, the second returned reflection to generate a second steered beam that is separated from the optical axis by a second offset; and
the multi-tip coupler is further to:
receive, from the optical element, a peak power of the second steered beam at an input of a second tip of the multi-tip coupler, the input of the second tip is separated from the optical axis by the second offset; and
combine energy from the multiple tips of the multi-tip coupler to generate a second single mode signal to be used for detecting a position of a second object.

17. The FMCW LIDAR system of claim 11, wherein the multi-tip coupler is further to:
provide the first single mode signal to a processing device via a single mode waveguide of the multi-tip coupler.

18. The FMCW LIDAR system of claim 11, wherein a maximum offset with respect to the optical axis that is supported by the multi-tip coupler is based on at least one of a width of the input of the first tip or a gap between the input of the first tip and an input of a second tip of the multi-tip coupler.

19. The FMCW LIDAR system of claim 11, wherein an insertion loss of the multi-tip coupler is based on at least one of a width of the first tip or a gap between the first tip and the second tip.

20. A FMCW LIDAR system comprising:
an optical scanner to:
receive a plurality of returned reflections that are respectively associated with a plurality of lag angles relative to an optical axis;
a multi-tip coupler comprising multiple tips, the multi-tip coupler to:
receive, for each returned reflection of the plurality of returned reflections, different amounts of power of the returned reflection at different tips of the multiple tips; and
generate a plurality of single mode signals based on the different amounts of power; and
a processing device coupled to the multi-tip coupler, the processing device to
detect a plurality of object positions based on the plurality of single mode signals.
